(19) United States
(12) Patent Application Publication
(10) Pub. No.: US 2006/0050810 A1
(43) Pub. Date: Mar. 9, 2006

(54) Hybrid transmitter architecture having high efficiency and large dynamic range

(75) Inventors: Tanbir Haque, Long Island City, NY (US); Leonid Kazakevich, Plainview, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/192,523

(22) Filed: Jul. 29, 2005

Related U.S. Application Data
(60) Provisional application No. 60/592,273, filed on Jul. 29, 2004.

(51) Int. Cl. H04L 25/49; H04L 27/20

(52) U.S. Cl. 375/297; 375/308

(57) ABSTRACT

An adaptive hybrid transmitter architecture for use in a communication unit which dynamically adapts to maximize efficiency, delivers a large dynamic range and provides good distortion performance depending upon the required output power of the transmitter. In the upper portion of the operating range, the hybrid transmitter operates in a sigma delta mode including a noise shaping feedback loop. In the middle portion of the operating range, the transmitter operates in a Cartesian correction mode for error correction. At the lower portion of the operating range, the amplifier is operated in a linear mode, without feedback.

### CROSS REFERENCE TO RELATED APPLICATION

This application claims the benefit of U.S. provisional application No. 60/592,273 filed on Jul. 29, 2004, which is incorporated by reference as if fully set forth herein.

### FIELD OF INVENTION

The present invention generally relates to transmitters. More specifically, the invention relates to an adaptive hybrid transmitter architecture for use in a communication unit, such as a wireless transmit/receive unit (WTRU) or a Node-B, where the characteristics of a Cartesian feedback loop and the bias level of the forward path radio frequency (RF) amplifiers are adjusted to maximize transmitter efficiency, deliver a large dynamic range and provide good distortion performance.

### BACKGROUND

Since the transmitter is a critical component of a communication unit, the architecture of a transmitter has a great impact upon the performance of the communication unit which employs the transmitter. The architecture of the transmitter can affect many performance aspects, such as the power consumption, (and thus the efficiency), the dynamic range and the distortion performance. Unfortunately, these performance aspects are often competing.

Nowhere is the evidence of tradeoffs between these aspects greater than in the selection and employment of amplifiers in a transmitter. For example, both dynamic range and distortion performance are in direct competition with efficiency. With respect to Class A, AB, B and C amplifiers, as the conduction angle, (i.e., the initial bias), is reduced in order to increase efficiency, the distortion performance degrades. Likewise, with respect to switched mode amplifiers (Class E) switched mode amplifiers capable of delivering very high efficiency suffer from poor dynamic range.

A current trend in communication units is to employ heavy class AB power amplifiers (i.e., close to class B) for constant envelope modulation schemes and weak class AB power amplifiers (i.e., close to class A) for non-constant envelope modulation schemes.

Some transmitters employ class AB power amplifiers having a sliding bias to enhance the overall transmitter efficiency and extend battery life. In this scheme, the power amplifier bias current is changed in proportion to the average transmitted power. The bias current is reduced when the transmitter backs off from maximum output power, thereby preserving the peak efficiency over more of the operating range. The peak efficiency of a practical class AB amplifier is at most 40%. As the output power of a class AB amplifier is backed off from maximum, the efficiency drops drastically. The purpose of the sliding bias technique is to preserve the peak efficiency of the class AB amplifier over more of the operating range. It is important to note even at maximum output power the efficiency of the class AB amplifier is far less than switched mode power amplifier efficiency levels.

Switched mode power amplifiers are known to theoretically achieve 100% efficiency. Practical implementations of switch mode power amplifiers have been shown to achieve better than 50% (typically 60% to 70%) power added efficiency. However, the dynamic range of a low cost switched mode power amplifier suitable for wireless grade transmitters is typically less than 30 dB. Practical implementations often require a much greater dynamic range. For example, a third Generation Partnership Project (3GPP) time division duplex (TDD) and frequency division duplex (FDD) transmitter must be able to support at least an 80 dB operating (output power) range.

Accordingly, there is a great need to improve transmitter efficiency while maintaining a large dynamic range and providing good distortion performance.

### SUMMARY

The present invention is an adaptive hybrid transmitter architecture for use in a communication unit. The transmitter dynamically adapts to maximize transmitter efficiency, deliver a large dynamic range and provide good distortion performance depending upon the required output power of the transmitter.

In the upper portion of the operating range, the hybrid transmitter loop operates in a sigma-delta mode to shape and push noise out of the band of interest. An RF band-select filter is then used to eliminate the shaped noise that falls outside of the band of interest. In the middle portion of the operating range, the transmitter loop operates with the characteristics of a Cartesian feedback loop for error correction. In the lower portion of the operating range, the transmitter is operated in the open loop mode with the RF amplifiers in linear mode.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a block diagram of an adaptive hybrid transmitter which maximizes efficiency, maintains a large dynamic range and provides good distortion performance in accordance with the present invention; and

FIG. 2 is a graphical representation of the output power operating range of the adaptive hybrid transmitter of FIG. 1.

### DETAILED DESCRIPTION OF THE PREFERRED EMBODIMENT

Although the present invention is described with reference to a wireless environment, its applicability is not limited to wireless applications. Hereafter, the terminology “WTRU” includes but is not limited to a user equipment (UE), a mobile station, a fixed or mobile subscriber unit, a pager, or any other type of device capable of operating in a wireless environment. When referred to hereafter, a base station includes but is not limited to a Node-B, a site controller, an access point (AP) or any other type of interfacing device in a wireless environment.

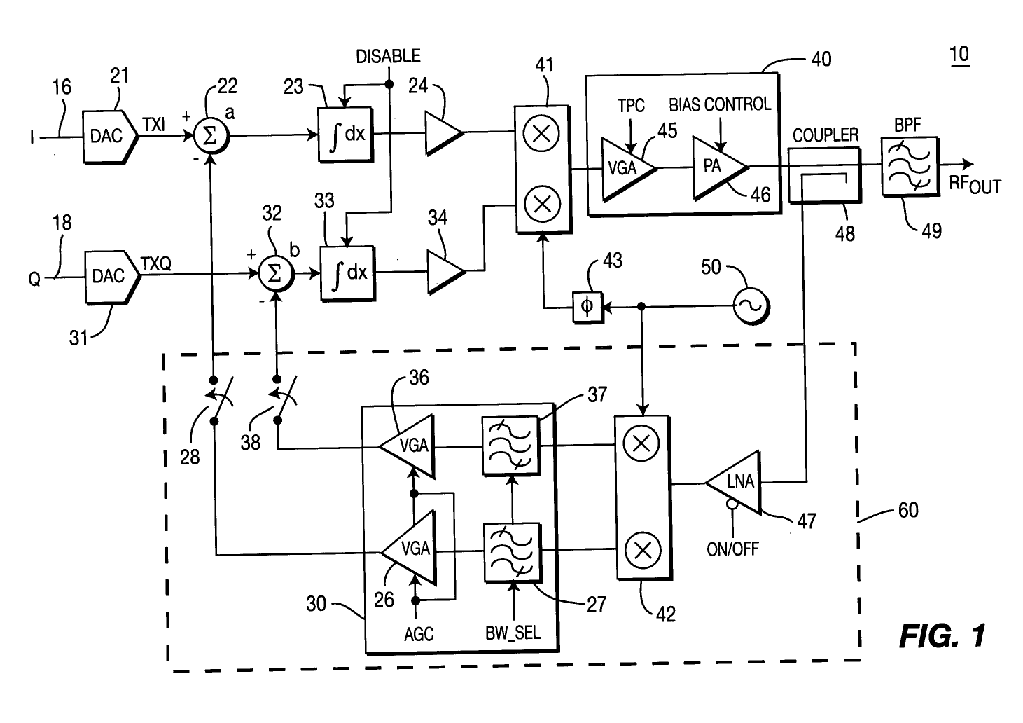

FIG. 1 is a block diagram of an adaptive hybrid transmitter 10, where the characteristics of the feedback loop (in either a Cartesian mode or sigma-delta mode) and the bias level of the forward path RF amplifiers are adjusted to maximize transmitter efficiency, deliver a large dynamic range and provide good distortion performance. Preferably, the hybrid transmitter 10 is incorporated within a WTRU. The hybrid transmitter 10 may be located on a single integrated circuit (IC) chip, or may be implemented as discrete components selectively coupled together.

The hybrid transmitter 10 comprises I and Q digital-to-analog converters (DACs) 21, 31; summers 22, 32; integrators 23, 33 baseband amplifiers 24, 34; an upconverter 41; a transmission amplifier 40, a coupler 48; a band-select filter 49; a local oscillator 50; a phase shifter 43; and a feedback unit 60.

The transmission amplifier 40 includes a variable gain amplifier 45 and a final stage power amplifier 46. The variable gain amplifier 45 is preferably a Class AB type amplifier which provides good efficiency. The variable gain is controlled by a transmit power control (TPC) command signal. The final stage power amplifier 46 is preferably a soft limiting, class B power amplifier with a bias control input. The function of TPC and the bias control on the forward path amplifiers 45, 46 are well known and therefore will not be explained in detail hereinafter.

The feedback unit 60 is coupled to the coupler 48, and comprises a low noise amplifier (LNA) 47; a downconverter 42; a feedback receiver 30; and switches 28, 38. The feedback receiver 30 includes programmable bandwidth filters 27, 37 and baseband variable gain amplifiers 26, 36.

The programmable filters 27, 37 are preconfigured according to the particular application, and selectively change depending upon the portion of operating range in which the hybrid transmitter 10 is operating, as will be explained in detail hereinafter.

The local oscillator 50 provides a direct feed to the downconverter 42 and a feed to the upconverter 41 via a phase shifter 43. It should be understood by those of skill in the art that use of the phase shifter 43 is only one possible embodiment. It is only necessary to have the ability to change the phase relation between the upconverter 41 and the downconverter 42.

During operation of a WTRU, once a communication link is established, such as with a base station, the hybrid transmitter 10 receives a baseband data signal for transmission via I and Q inputs 16, 18. The data is then converted via DACs 21,31 and sent to the summers 22, 32, the integrators 23, 33 and then the baseband amplifiers 24, 34 prior to upconversion by the upconverter 41. The upconverted signals are then amplified by the transmission amplifier 40 and filtered by the band-select filter 49 prior to transmission (RFₒᵤₜ).

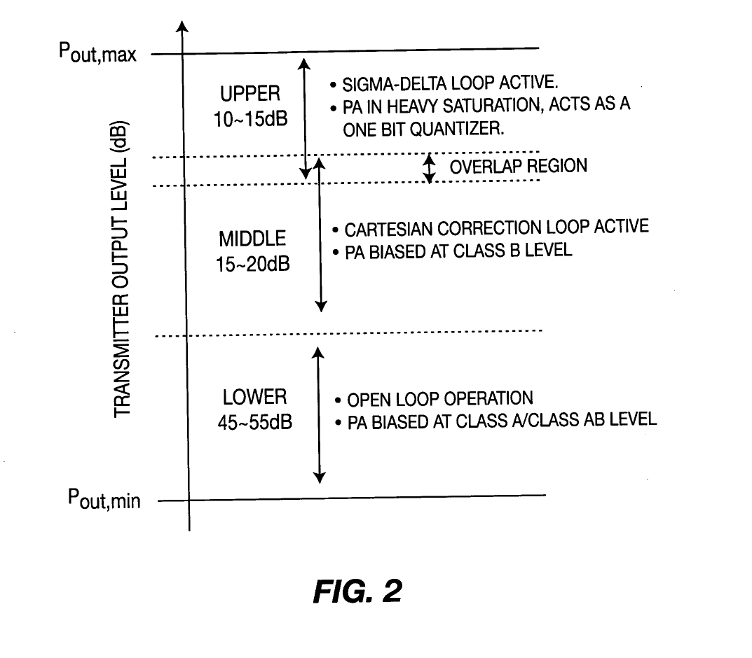

The hybrid transmitter 10 of the present invention dynamically adjusts to maximize transmitter efficiency, maintain dynamic range and minimize distortion depending upon the required output power of the transmitter 10. The output power of the transmitter 10 output can generally be categorized as falling within one of three portions of the operating range: upper, middle, and lower with a small overlap region between the upper and middle portions. This is shown in FIG. 2.

In the upper portion of the operating range, (i.e. from maximum output power to 10 dB to 15 dB below maximum output power), the hybrid transmitter 10 is operated in the sigma-delta mode by pushing the final stage power amplifier 46 into heavy compression. Since the theory and operation of sigma-delta loops are well known to those of skill in the art, a detailed explanation will not be set forth herein. Briefly, however, when the final stage power amplifier 46 is pushed into heavy compression, it operates as a one-bit quantizer with approximately square wave output. Although only the final stage power amplifier 46 need be in compression for the hybrid transmitter 10 to operate in the sigma-delta mode, it should be noted that compression of the entire transmission amplifier 40, (i.e., both the variable gain amplifier 45 and the final stage power amplifier 46), will also enter the hybrid transmitter 10 into the sigma-delta mode.

In the sigma-delta mode, the final stage power amplifier 46 operates essentially as a switch and therefore very good efficiency is achieved. The band-select filter 49 sets the noise bandwidth of the system. The band-select filter 49 filters out the shaped noise that falls outside of the band of interest.

The feedback unit 60 in the sigma-delta mode forms a noise shaping loop. The bandwidth of the low pass filters 27,37 in the feedback unit 60, are set at half the noise bandwidth or higher, which is the RF band of interest. For example, for FDD the RF band of interest is 60 MHz; and for TDD it could be 20 MHz or less.

The transition from the upper portion of the operating range to the middle portion of the operating range and, vise versa, is a smooth and automatic transition, as shown in the transition region in FIG. 2. The initial bias of the final stage power amplifier 46 will determine the transition point.

In the middle portion of the operating range, (i.e., starting at approximately 0 to 15 dB below maximum output power and having a range of approximately 15 to 20 dB), the hybrid transmitter 10 is operated in a Cartesian correction mode, whereby the feedback unit 60 acts to complete a Cartesian correction loop. As those of skill in the art would appreciate, there are errors that are introduced into the forward transmission path by the non-linearity of certain components such as the up-converter 41, the variable gain amplifier 45 and the final stage power amplifier 46. Therefore, it is desirable to compensate for these non-linearities.

In this middle portion of the operating range, the I and Q components fed from the feedback unit 60, perform pre-distortion of the I, Q components from the DACs 21, 31 at each of the summers 22, 32 in order to subtract from the original inputs the orthogonal error signals introduced by the non-linearities of the up-converter 41, the variable gain amplifier 45 and the final stage power amplifier 40. Note that in the Cartesian correction mode, the integrators 23,33 in the forward path are not necessary and therefore are disabled. In contrast, however, the integrators 23, 33 are preferred in the sigma-delta mode.

In an alternative embodiment, a switch (not shown) may be provided to switch out the integrators 23, 33 when in the Cartesian correction mode. In this embodiment, low pass filters are switched in place of the integrators 23, 33. The purpose of the low pass filters is to limit the DAC image frequencies. The low pass filters and switching mechanism are not explicitly shown in FIG. 1 for simplicity.

The final stage power amplifier 46 in the Cartesian correction mode is operated as a linear amplifier. The final stage power amplifier 46 achieves, at best, class B (50% practical) efficiency levels. The bulk of the distortion in this range of operation is likely to come from the final stage power amplifier 46. The feedback unit 60 operating as Cartesian correction loop helps to linearize, (i.e., reduce distortion levels), the entire forward path transmitter, (the upconverter 41, the variable gain amplifier 45 and the final stage power amplifier 46).

In this mode, the programmable filters 27, 37 are set at three (3) to five (5) times the baseband I,Q bandwidth, (half the RF bandwidth), of the transmitted signal.

Finally, as the input power reaches the lower portion of the operating range, (i.e., starting at approximately 35 dB below maximum output power and extending to approximately 80 dB below maximum output power), the hybrid transmitter 10 operates in the open loop mode, whereby feedback from the feedback unit 60 is disconnected by positioning the switches 28, 38, in the open position. The bias to the final stage power amplifier 46 may be set to class AB or class A as necessary. In this mode, (similar to the Cartesian correction mode), the integrators 23, 33 are preferably switched out and replaced by low pass filters. This is not explicitly shown in FIG. 1 for the sake of simplicity.

In order for proper operation of the hybrid transmitter 10, it is critical that the up-conversion and down-conversion processes are properly aligned. Therefore, a single local oscillator 50, in conjunction with the phase shifter 43 supplies the modulating frequency for the upconverter 41 and the downconverter 42. When operating the feedback unit 60 in either the sigma-delta or the Cartesian mode, the phase shifter 43 is adjusted to align the baseband signals; (i.e. the I and Q outputs from the DACs 21, 31 and the baseband signals from the feedback unit 60 arriving at the input of the summers 22, 32). This compensates for the different delays associated with the components, (the upconverter 41, the variable gain amplifier 45 the final stage power amplifier 46, the downconverter 42, the low noise amplifier 47), in the forward and reverse feedback paths. The phase shifter 43 is used to align the phases of the upconversion and downconversion processes, thereby ensuring that a negative feedback system is created and that the phase margin of the system is optimized. In the lower portion of the operating range, when the feedback loop is opened, the phase shifter 43 is not necessary.

Transmit output power control is achieved through the combination of the variable gain amplifier 45, the feedback variable gain amplifiers 26, 36, and the LNA 47, in the two closed loop (sigma-delta, Cartesian loop) modes of operation. In the open loop mode, transmit output power control is achieved through the forward variable gain amplifier alone. The use of forward and reverse path gain elements to set the overall output level of a loop structure is well known to those of skill in the art and, therefore, will not be set forth in detail hereinafter.

It should be noted that all three modes of the hybrid transmitter need not be employed under all conditions. For example, only the sigma-delta and the Cartesian loop modes may be employed for transmitters required to deliver a small output power range (<40 dB). A standard may require only 40 dB of operating range instead of 80 dB, as in the case of FDD. As such, the upper and the middle regions are sufficient. Therefore, not all transmitters will have to employ all three regions. The number of regions required will be determined by the operating range.

Although the features and elements of the present invention are described in the preferred embodiments in particular combinations, each feature or element can be used alone without the other features and elements of the preferred embodiments or in various combinations with or without other features and elements of the present invention.

What is claimed is:

1. An adaptive hybrid transmitter for transmitting a radio frequency (RF) signal within an established power output level operating range, the transmitter being configured to selectively operate in an upper portion of the operating range, a middle portion of the operating range, and a lower portion of the operating range, the transmitter comprising:
(a) an in-phase (I) signal path;
(b) a quadrature (Q) signal path;
(c) a first summer inserted in the I signal path;
(d) a second summer inserted in the Q signal path;
(e) an upconverter having a first input connected to the I signal path, a second input connected to the Q signal path, and an output for outputting an upconverted signal derived from signals received on the I and Q signal paths;
(f) at least one amplifier which amplifies the upconverted signal;
(g) a coupler in communication with the upconverted signal output of the upconverter, the coupler having a direct output and a coupled output; and
(h) a feedback unit having an input in communication with the coupled output of the coupler and two switchable outputs in communication with respective inputs of the first summer and the second summer.

2. The transmitter of claim 1 wherein the at least one amplifier is a transmission amplifier which includes a variable gain amplifier (VGA) in series with a final stage power amplifier (PA).

3. The transmitter of claim 2 wherein the VGA is an efficient class AB type amplifier.

4. The transmitter of claim 2 wherein the VGA is controlled by a transmit power control (TPC) command signal.

5. The transmitter of claim 2 wherein the final stage PA is a soft limiting, class B type amplifier.

6. The transmitter of claim 2 wherein the final stage PA is controlled by a bias control input signal.

7. The transmitter of claim 1 further comprising:
(i) a first integrator inserted in the I signal path between the first summer and the first input of the upconverter; and
(j) a second integrator inserted in the Q signal path between the second summer and the second input of the upconverter.

8. The transmitter of claim 7 wherein the transmitter is forced into a sigma-delta mode by pushing the at least one amplifier into heavy compression when the transmitter operates in the upper operating range.

9. The transmitter of claim 7 wherein the first and second integrators are disabled when the transmitter operates in the middle portion of the operating range.

10. The transmitter of claim 7 wherein the first and second integrators are switched out of the I and Q signal paths when the transmitter operates in the middle portion of the operating range.

11. The transmitter of claim 7 further comprising:
(k) a first amplifier inserted in the I signal path between the first integrator and the first input of the upconverter; and
(l) a second amplifier inserted in the Q signal path between the second integrator and the second input of the upconverter.

12. The transmitter of claim 1 further comprising a bandpass filter coupled to the direct output of the coupler, wherein the bandpass filters an RF signal output generated by the transmitter.

13. The transmitter of claim 1 wherein the feedback unit compensates for errors that are introduced by the non-linearity of the upconverter when the transmitter operates in the middle portion of the operating range.

14. The transmitter of claim 2 wherein the feedback unit compensates for errors that are introduced by the non-linearity of the VGA when the transmitter operates in the middle portion of the operating range.

15. The transmitter of claim 2 wherein the feedback unit compensates for errors that are introduced by the non-linearity of the final stage PA when the transmitter operates in the middle portion of the operating range.

16. The transmitter of claim 1 further comprising:
(i) a first digital-to-analog converter (DAC) inserted in the I signal path before the first summer, the first DAC being configured to convert a baseband signal to a first converted signal that is fed to a first input of the first summer; and
(j) a second DAC inserted in the Q signal path before the second summer, the second DAC being configured to convert a baseband signal to a second converted signal that is fed to a first input of the second summer.

17. The transmitter of claim 16 wherein the feedback unit (h) comprises:
(h1) a low noise amplifier (LNA) having an input in communication with the coupled output of the coupler;
(h2) a downconverter having an input connected to an output of the LNA, an I signal output and a Q signal output;
(h3) a feedback receiver in communication with the I and Q signal outputs of the downconverter, the feedback receiver having an I signal output and a Q signal output;
(h4) a first switch inserted between the I signal output of the feedback receiver and the input of the first summer; and
(h5) a second switch inserted between the Q signal output of the feedback receiver and the input of the second summer.

18. The transmitter of claim 17 further comprising a local oscillator (LO) for supplying a modulating frequency to the upconverter and the downconverter.

19. The transmitter of claim 18 further comprising a phase shifter inserted between the LO and the upconverter, wherein the phase shifter aligns the phases of the upconverter output and the downconverter output.

20. The transmitter of claim 17 wherein the feedback receiver (h3) comprises:
(i) a first programmable bandwidth filter in communication with the I signal output of the down converter;
(ii) a first baseband variable gain amplifier (VGA) in communication with the first programmable bandwidth filter and the first switch;
(iii) a second programmable bandwidth filter in communication with the Q signal output of the down converter; and
(iv) a second baseband VGA in communication with the second programmable bandwidth filter and the second switch.

21. The transmitter of claim 20 wherein when the first and second switches are closed such that the feedback unit is enabled, the output of the first baseband VGA is fed to a second input of the first summer and summed with the output of the first DAC, and the output of the second baseband VGA is fed to a second input of the second summer and summed with the output of the second DAC.

22. The transmitter of claim 1 wherein the feedback unit serves to complete a Cartesian correction loop within the transmitter.

23. The transmitter of claim 17 wherein the first and second switches are opened such that the feedback unit is disabled when the transmitter operates in the lower portion of the operating range.

24. A wireless transmit/receive unit (WTRU) for transmitting a radio frequency (RF) signal within an established power output level operating range, the WTRU being configured to selectively operate in an upper portion of the operating range, a middle portion of the operating range, and a lower portion of the operating range, the WTRU comprising:
(a) an in-phase (I) signal path;
(b) a quadrature (Q) signal path;
(c) a first summer inserted in the I signal path;
(d) a second summer inserted in the Q signal path;
(e) an upconverter having a first input connected to the I signal path, a second input connected to the Q signal path, and an output for outputting an upconverted signal derived from signals received on the I and Q signal paths;
(f) at least one amplifier which amplifies the upconverted signal;
(g) a coupler in communication with the upconverted signal output of the upconverter, the coupler having a direct output and a coupled output; and
(h) a feedback unit having an input in communication with the coupled output of the coupler and two switchable outputs in communication with respective inputs of the first summer and the second summer.

25. The WTRU of claim 24 wherein the at least one amplifier is a transmission amplifier which includes a variable gain amplifier (VGA) in series with a final stage power amplifier (PA).

26. The WTRU of claim 25 wherein the VGA is an efficient class AB type amplifier.

27. The WTRU of claim 25 wherein the VGA is controlled by a transmit power control (TPC) command signal.

28. The WTRU of claim 25 wherein the final stage PA is a soft limiting, class B type amplifier.

29. The WTRU of claim 25 wherein the final stage PA is controlled by a bias control input signal.

30. The WTRU of claim 24 further comprising:
(i) a first integrator inserted in the I signal path between the first summer and the first input of the upconverter; and
(j) a second integrator inserted in the Q signal path between the second summer and the second input of the upconverter.

31. The WTRU of claim 30 wherein the WTRU is forced into a sigma-delta mode by pushing the at least one amplifier into heavy compression when the WTRU operates in the upper operating range.

32. The WTRU of claim 30 wherein the first and second integrators are disabled when the WTRU operates in the middle portion of the operating range.

33. The WTRU of claim 30 wherein the first and second integrators are switched out of the I and Q signal paths when the WTRU operates in the middle portion of the operating range.

34. The WTRU of claim 30 further comprising:
(k) a first amplifier inserted in the I signal path between the first integrator and the first input of the upconverter; and
(l) a second amplifier inserted in the Q signal path between the second integrator and the second input of the upconverter.

35. The WTRU of claim 24 further comprising a bandpass filter coupled to the direct output of the coupler, wherein the bandpass filters an RF signal output generated by the WTRU.

36. The WTRU of claim 24 wherein the feedback unit compensates for errors that are introduced by the non-linearity of the upconverter when the WTRU operates in the middle portion of the operating range.

37. The WTRU of claim 25 wherein the feedback unit compensates for errors that are introduced by the non-linearity of the VGA when the WTRU operates in the middle portion of the operating range.

38. The WTRU of claim 25 wherein the feedback unit compensates for errors that are introduced by the non-linearity of the final stage PA when the WTRU operates in the middle portion of the operating range.

39. The WTRU of claim 24 further comprising:
(i) a first digital-to-analog converter (DAC) inserted in the I signal path before the first summer, the first DAC being configured to convert a baseband signal to a first converted signal that is fed to a first input of the first summer; and
(j) a second DAC inserted in the Q signal path before the second summer, the second DAC being configured to convert a baseband signal to a second converted signal that is fed to a first input of the second summer.

40. The WTRU of claim 39 wherein the feedback unit (h) comprises:
(h1) a low noise amplifier (LNA) having an input in communication with the coupled output of the coupler;
(h2) a downconverter having an input connected to an output of the LNA, an I signal output and a Q signal output;
(h3) a feedback receiver in communication with the I and Q signal outputs of the downconverter, the feedback receiver having an I signal output and a Q signal output;
(h4) a first switch inserted between the I signal output of the feedback receiver and the input of the first summer; and
(h5) a second switch inserted between the Q signal output of the feedback receiver and the input of the second summer.

41. The WTRU of claim 40 further comprising a local oscillator (LO) for supplying a modulating frequency to the upconverter and the downconverter.

42. The WTRU of claim 41 further comprising a phase shifter inserted between the LO and the upconverter, wherein the phase shifter aligns the phases of the upconverter output and the downconverter output.

43. The WTRU of claim 40 wherein the feedback receiver (h3) comprises:
(i) a first programmable bandwidth filter in communication with the I signal output of the down converter;
(ii) a first baseband variable gain amplifier (VGA) in communication with the first programmable bandwidth filter and the first switch;
(iii) a second programmable bandwidth filter in communication with the Q signal output of the down converter; and
(iv) a second baseband VGA in communication with the second programmable bandwidth filter and the second switch.

44. The WTRU of claim 43 wherein when the first and second switches are closed such that the feedback unit is enabled, the output of the first baseband VGA is fed to a second input of the first summer and summed with the output of the first DAC, and the output of the second baseband VGA is fed to a second input of the second summer and summed with the output of the second DAC.

45. The WTRU of claim 24 wherein the feedback unit serves to complete a Cartesian correction loop within the WTRU.

46. The WTRU of claim 40 wherein the first and second switches are opened such that the feedback unit is disabled when the WTRU operates in the lower portion of the operating range.

47. An integrated circuit incorporated in a transmitter for transmitting a radio frequency (RF) signal within an established power output level operating range, the IC being configured to selectively operate in an upper portion of the operating range, a middle portion of the operating range, and a lower portion of the operating range, the IC comprising:
(a) an in-phase (I) signal path;
(b) a quadrature (Q) signal path;
(c) a first summer inserted in the I signal path;
(d) a second summer inserted in the Q signal path;
(e) an upconverter having a first input connected to the I signal path, a second input connected to the Q signal path, and an output for outputting an upconverted signal derived from signals received on the I and Q signal paths;
(f) at least one amplifier which amplifies the upconverted signal;
(g) a coupler in communication with the upconverted signal output of the upconverter, the coupler having a direct output and a coupled output; and
(h) a feedback unit having an input in communication with the coupled output of the coupler and two switchable outputs in communication with respective inputs of the first summer and the second summer.

48. The IC of claim 47 wherein the at least one amplifier is a transmission amplifier which includes a variable gain amplifier (VGA) in series with a final stage power amplifier (PA).

49. The IC of claim 48 wherein the VGA is an efficient class AB type amplifier.

50. The IC of claim 48 wherein the VGA is controlled by a transmit power control (TPC) command signal.

51. The IC of claim 48 wherein the final stage PA is a soft limiting, class B type amplifier.

52. The IC of claim 48 wherein the final stage PA is controlled by a bias control input signal.

53. The IC of claim 47 further comprising:
(i) a first integrator inserted in the I signal path between the first summer and the first input of the upconverter; and
(j) a second integrator inserted in the Q signal path between the second summer and the second input of the upconverter.

54. The IC of claim 53 wherein the IC is forced into a sigma-delta mode by pushing the at least one amplifier into heavy compression when the IC operates in the upper operating range.

55. The IC of claim 53 wherein the first and second integrators are disabled when the IC operates in the middle portion of the operating range.

56. The IC of claim 53 wherein the first and second integrators are switched out of the I and Q signal paths when the IC operates in the middle portion of the operating range.

57. The IC of claim 53 further comprising:
(k) a first amplifier inserted in the I signal path between the first integrator and the first input of the upconverter; and
(l) a second amplifier inserted in the Q signal path between the second integrator and the second input of the upconverter.

58. The IC of claim 47 further comprising a bandpass filter coupled to the direct output of the coupler, wherein the bandpass filters an RF signal output generated by the IC.

59. The IC of claim 47 wherein the feedback unit compensates for errors that are introduced by the non-linearity of the upconverter when the IC operates in the middle portion of the operating range.

60. The IC of claim 48 wherein the feedback unit compensates for errors that are introduced by the non-linearity of the VGA when the IC operates in the middle portion of the operating range.

61. The IC of claim 48 wherein the feedback unit compensates for errors that are introduced by the non-linearity of the final stage PA when the IC operates in the middle portion of the operating range.

62. The IC of claim 47 further comprising:
(i) a first digital-to-analog converter (DAC) inserted in the I signal path before the first summer, the first DAC being configured to convert a baseband signal to a first converted signal that is fed to a first input of the first summer; and
(j) a second DAC inserted in the Q signal path before the second summer, the second DAC being configured to convert a baseband signal to a second converted signal that is fed to a first input of the second summer.

63. The IC of claim 62 wherein the feedback unit (h) comprises:
(h1) a low noise amplifier (LNA) having an input in communication with the coupled output of the coupler;
(h2) a downconverter having an input connected to an output of the LNA, an I signal output and a Q signal output;
(h3) a feedback receiver in communication with the I and Q signal outputs of the downconverter, the feedback receiver having an I signal output and a Q signal output;
(h4) a first switch inserted between the I signal output of the feedback receiver and the input of the first summer; and
(h5) a second switch inserted between the Q signal output of the feedback receiver and the input of the second summer.

64. The IC of claim 63 further comprising a local oscillator (LO) for supplying a modulating frequency to the upconverter and the downconverter.

65. The IC of claim 64 further comprising a phase shifter inserted between the LO and the upconverter, wherein the phase shifter aligns the phases of the upconverter output and the downconverter output.

66. The IC of claim 63 wherein the feedback receiver (h3) comprises:
(i) a first programmable bandwidth filter in communication with the I signal output of the down converter;
(ii) a first baseband variable gain amplifier (VGA) in communication with the first programmable bandwidth filter and the first switch;
(iii) a second programmable bandwidth filter in communication with the Q signal output of the down converter; and
(iv) a second baseband VGA in communication with the second programmable bandwidth filter and the second switch.

67. The IC of claim 66 wherein when the first and second switches are closed such that the feedback unit is enabled, the output of the first baseband VGA is fed to a second input of the first summer and summed with the output of the first DAC, and the output of the second baseband VGA is fed to a second input of the second summer and summed with the output of the second DAC.

68. The IC of claim 47 wherein the feedback unit serves to complete a Cartesian correction loop within the IC.

69. The IC of claim 63 wherein the first and second switches are opened such that the feedback unit is disabled when the IC operates in the lower portion of the operating range.
